(19) United States
(12) Patent Application Publication
(10) Pub. No.: US 2009/0244906 A1
(43) Pub. Date: Oct. 1, 2009

(54) DISPLAY APPARATUS AND METHOD OF MANUFACTURING THE SAME

(75) Inventor: Myung-Hwan KIM, Yongin-si (KR)

Correspondence Address: H.C. PARK & ASSOCIATES, PLC, 8500 LEESBURG PIKE, SUITE 7500, VIENNA, VA, 22182, US

(73) Assignee: Samsung Electronics Co., Ltd., Suwon-si (KR)

(21) Appl. No.: 12/347,381

(22) Filed: Dec. 31, 2008

(30) Foreign Application Priority Data
Mar. 31, 2008 (KR) 10-2008-0029880

(51) Int. Cl. F21V 13/04

(52) U.S. Cl. 362/327

(57) ABSTRACT

In a method of manufacturing a display apparatus, a light reflecting layer is formed on at least one of two substrates facing each other and reflects ultraviolet rays irradiated onto the substrates. The light reflecting layer includes first and second layers that have different refractive indexes from each other and are sequentially stacked. The light reflecting layer may selectively reflect ultraviolet rays having a specific wavelength, and the specific wavelength of ultraviolet rays that are reflected by the light reflecting layer may be controlled by the refractive indexes of the first and second layers and the thicknesses of the first and second layers.

### CROSS-REFERENCE TO RELATED APPLICATION

This application claims priority from and the benefit of Korean Patent Application No. 10-2008-0029880, filed on Mar. 31, 2008, which is hereby incorporated by reference for all purposes as if fully set forth herein.

### BACKGROUND OF INVENTION

1. Field of the Invention

The present invention relates to a display apparatus, a method of manufacturing the same, and an organic light emitting display. More particularly, the present invention relates to a display apparatus that may reflect ultraviolet rays of a specific wavelength, a method of manufacturing the display apparatus, and an organic light emitting display.

2. Discussion of the Background

In general, a display apparatus that displays an image using light provided from a separate light source may include two substrates and an optical shutter disposed between the two substrates. The optical shutter controls the amount of light passing through the two substrates. A display apparatus, which includes an optical shutter, may be a liquid crystal display, in which a liquid crystal layer serves as the optical shutter. For instance, a plastic liquid crystal display may include two substrates made of flexible plastic and a liquid crystal layer.

In the plastic liquid crystal display, since the substrates include a flexible material, it may be difficult to form devices on the substrates. Thus, carrier substrates made of a hard material may be coupled to the substrates using an adhesive layer before the devices are formed on the substrates.

After all of the devices are formed on the substrates, the two substrates are coupled to the carrier substrates and a liquid crystal layer is disposed between the two substrates. Then, ultraviolet rays are irradiated onto the adhesive layer to separate the carrier substrate from each substrate, and the manufacture of a display panel for the plastic liquid crystal display is completed. However, since the ultraviolet rays are irradiated onto the liquid crystal layer while separating the carrier substrates from the two substrates, chemical and physical properties of the liquid crystal layer may vary due to the ultraviolet rays.

### SUMMARY OF INVENTION

The present invention provides a display apparatus that may prevent deterioration of a driving operation thereof due to ultraviolet rays.

The present invention also provides a method of manufacturing the display apparatus.

The present invention also provides an organic light emitting device that may prevent deterioration of a driving operation thereof due to ultraviolet rays.

Additional features of the invention will be set forth in the description which follows, and in part will be apparent from the description, or may be learned by practice of the invention

The present invention discloses a display apparatus including a first substrate, a second substrate facing the first substrate, an optical shutter disposed between the first substrate and the second substrate, and a light reflecting layer arranged on at least one of the first and second substrates to reflect ultraviolet rays that comprise a specific wavelength and that are irradiated onto the at least one of the first and second substrates. The light reflecting layer comprises a first layer comprising a first refractive index, and a second layer comprising a second refractive index different from the first refractive index and arranged on the first layer.

The present invention also discloses a method of manufacturing a display apparatus including forming a first layer having a first refractive index and a second layer having a second refractive index different from the first refractive index are on a first substrate to form a first light reflecting layer to reflect ultraviolet rays having a first wavelength. A first adhesive layer is formed on a first carrier substrate, and the first substrate is coupled to the first carrier substrate such that the first light reflecting layer is disposed between the first substrate and the first adhesive layer. Also, a third layer having a third refractive index and a fourth layer having a fourth refractive index different from the third refractive index are formed on a second substrate to form a second light reflecting layer to reflect ultraviolet rays having a second wavelength. A second adhesive layer is formed on a second carrier substrate, and the second substrate is coupled with the second carrier substrate such that the second light reflecting layer is disposed between the second substrate and the second adhesive layer. After manufacturing the first substrate coupled with the first carrier substrate and the second substrate coupled to the second carrier substrate, the first substrate is coupled with the second substrate. An optical shutter is disposed between the first and second substrates.

The present invention also discloses an organic light emitting display including a first substrate, a second substrate facing the first substrate, an organic light emitting layer arranged on the first substrate to emit a light, and a light reflecting layer arranged on at least one of the first and second substrates to reflect ultraviolet rays that have a specific wavelength and that are irradiated onto the at least one of the first substrate and the second substrate. The light reflecting layer includes a first layer having a first refractive index and a second layer having a second refractive index different from the first refractive index and arranged on the first layer.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a perspective view showing a liquid crystal display according to an exemplary embodiment of the present invention.

FIG. 2 is a cross-sectional view taken along line I-I′ of FIG. 2.

FIG. 3 is a sectional view showing a liquid crystal display according to another exemplary embodiment of the present invention.

FIG. 4 is a sectional view showing a liquid crystal display according to another exemplary embodiment of the present invention;

FIG. 5, FIG. 6, FIG. 7, FIG. 8, FIG. 9, FIG. 10, FIG. 11, FIG. 12, and FIG. 13 are process views showing a method of manufacturing the liquid crystal display of FIG. 1.

FIG. 14 is a sectional view showing an organic light emitting device according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on,” “connected to,” or “coupled to” another element or layer, it can be directly on, connected to, or coupled to the other element or layer or intervening elements or layers may be present. In contrast, when an element is referred to as being “directly on,” “directly connected to,” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers, and/or sections, these elements, components, regions, layers, and/or sections should not be limited by these terms. These terms are only used to distinguish one element, component, region, layer or section from another region, layer or section.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present invention will be explained in detail with reference to the accompanying drawings.

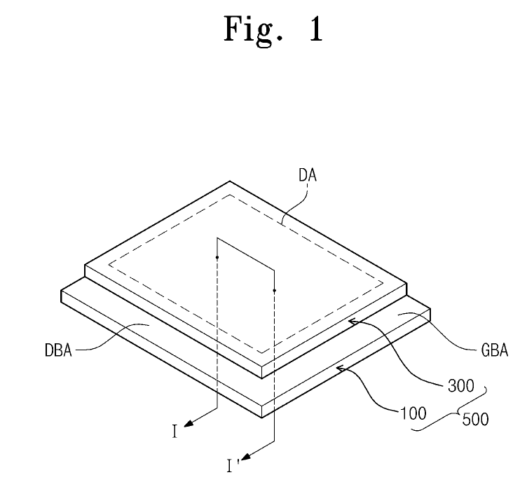

FIG. 1 is a perspective view showing a liquid crystal display according to an exemplary embodiment of the present invention.

Referring to FIG. 1, a liquid crystal display 500 includes a first substrate 100, a second substrate 300 facing the first substrate 100, and a liquid crystal layer (not shown) disposed between the first substrate 100 and the second substrate 300.

The liquid crystal display 100 includes a display area DA in which an image is displayed. The first substrate 100 includes a plurality of thin film transistors and a plurality of pixel electrodes that are connected to the thin film transistors, respectively. The thin film transistors and the pixel electrodes are arranged in the display area DA.

The liquid crystal display 500 further includes a gate bonding area GBA and a data bonding area DBA, which are defined outside the display area DA. Although not shown in FIG. 1, the liquid crystal display 500 may further include a gate driver connected to the first substrate 100 in the gate bonding area GBA and a data driver connected to the first substrate 100 in the data bonding area DBA.

Accordingly, the liquid crystal display 500 receives a gate signal from the gate driver to switch the thin film transistors and receives a pixel voltage from the data driver to apply the pixel voltage to the pixel electrodes.

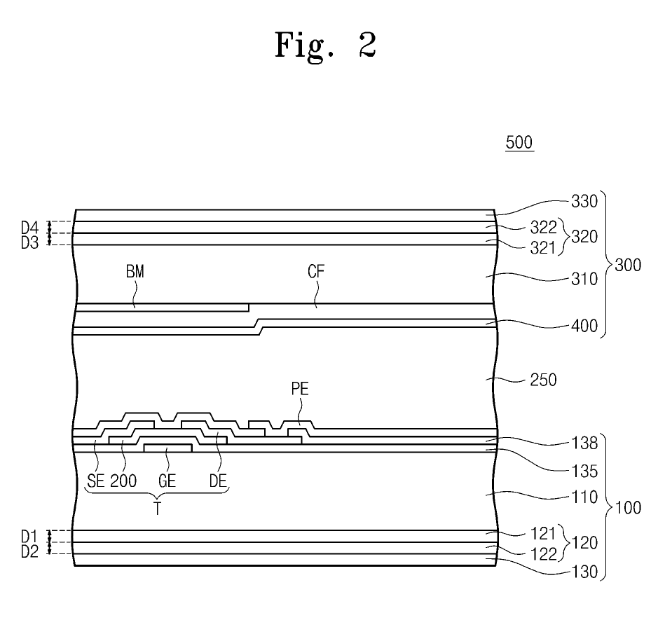

In addition, although not shown in FIG. 1, the first substrate 100 includes a first light reflecting layer 120 (see FIG. 2) and a first coating layer 130 (see FIG. 2), and the second substrate 300 includes a second light reflecting layer 320 (see FIG. 2) and a second coating layer 330 (see FIG. 2). These layers will be described in detail with reference to FIG. 2.

The liquid crystal layer serves as an optical shutter of the liquid crystal display 500. Although not shown in FIG. 1, the liquid crystal display 500 may further include a backlight to supply light to the first and second substrates 100 and 300. The liquid crystal display 500 displays an image using light passing through the first and second substrates 100 and 300, and the light transmittance of the liquid crystal layer depends on the alignment of the liquid crystals of the liquid crystal layer.

FIG. 2 is a cross-sectional view taken along line I-I′ of FIG. 2. In FIG. 2, one thin film transistor and one pixel electrode will be described as a representative example since the thin film transistors have the same structure and function and the pixel electrodes have the same structure and function.

Referring to FIG. 2, the first substrate 100 includes a first base substrate 110, the first light reflecting layer 120, the first coating layer 130, the thin film transistor T arranged on the first base substrate 110, and the pixel electrode PE connected to the thin film transistor T.

The first base substrate 110 includes a flexible material such as plastic and may have a plate-like shape or a sheet-like shape. Thus, although various external forces are applied to the first base substrate 110, the first base substrate 110 may be smoothly bent, thereby preventing the first base substrate 110 from being damaged.

The first coating layer 130 is arranged on an outer surface of the first substrate 100 to cover the first substrate 100. When the first substrate 100 is exposed to the exterior, damage, such as a scratch, may easily occur on the first substrate 100. However, since the first coating layer 130 is arranged on the outer surface of the first substrate 100, the outer surface of the first substrate 100 may be protected.

The light reflecting layer 120 is disposed between the first base substrate 110 and the first coating layer 130 and includes a first thin layer 121 and a second thin layer 122 arranged under the first thin layer 121. The first thin layer 121 has a first refractive index (n1) and a first thickness D1. The second thin layer 122 has a second refractive index (n2) different from the first refractive index (n1) and has a second thickness D2.

The first and second thin layers 121 and 122 may include an organic or inorganic material having a superior light transmittance. In the present exemplary embodiment, the organic material may include a polyacrylate polymer such as polymethylmethacrylate (PMMA), polystyrene (PS), or polyimide (PI). The inorganic material may include zinc oxide (ZnO), indium zinc oxide (IZO), indium tin oxide (ITO), silicon oxide (SiOₓ), aluminum oxide (AlₓO_{y}), or titanium oxide (TiOₓ).

The first light reflecting layer 120 reflects external ultraviolet rays 450 incident through the first coating layer 130. Especially, the first light reflecting layer 120 may reflect ultraviolet rays 450 (see FIG. 13) having a specific wavelength. The approximation value of the specific wavelength may be obtained using Equation 1.

λ=2×(n1×D1+n2×D2)×sin θ Equation 1

In Equation 1, n1 and n2 represent the first and second refractive indexes of the first and second thin layers 121 and 122, respectively, D1 and D2 represent the first and second thicknesses of the first and second thin layers 121 and 122, respectively, and θ represents an angle between a surface of the first light reflecting layer 120 and the light incident into the first reflecting layer 120.

When assuming that light is incident into the first light reflecting layer 120 at a right angle with respect to the first light reflecting layer 120 and sin θ is 1, the specific wavelength (λ) of the light reflected from the first light reflecting layer 120 may be obtained from Equation 1 using Bragg's law.

In Equation 1, n1, n2, D1, and D2 represent the first refractive index of the first thin layer 121, the second refractive index of the second thin layer 122, the first thickness of the first thin layer 121, and the second thickness of the second thin layer 122, respectively. Accordingly, the specific wavelength (λ) may be varied according to at least one of the first refractive index n1, the second refractive index n2, the first thickness D1, and the second thickness D2.

Referring to FIG. 13 and Equation 1, when manufacturing the liquid crystal display 500, the first light reflecting layer 120 is designed to reflect the ultraviolet rays 450 that have a wavelength of about 308 nm and are irradiated onto the first substrate 100 in order to separate a first carrier substrate 115 from the first substrate 100. For instance, when the first and second refractive indexes n1 and n2 are 1.56 and 1.49, respectively, the wavelength of the ultraviolet rays 450 that are reflected by the first light reflecting layer 120 may be about 308 nm by adjusting the first and second thicknesses D1 and D2.

Referring to FIG. 2 again, the thin film transistor T includes a gate electrode GE, a semiconductor pattern 200 arranged above the gate electrode GE, a source electrode SE, and a drain electrode DE. Since a gate insulating layer 135 is arranged on the first base substrate 110 to cover the gate electrode GE, the source and drain electrodes SE and DE arranged on the gate insulating layer 135 may be insulated from the gate electrode GE. An inter-insulating layer 138 is arranged above the first base substrate 110 to cover the thin film transistor T. In addition, the pixel electrode PE is arranged on the inter-insulating layer 138 and connected to the drain electrode DE through a contact hole that is formed through the inter-insulating layer 138.

Meanwhile, the second substrate 300 includes a second base substrate 310, a second light reflecting layer 320, a second coating layer 330, a black matrix BM, a color filter CF, and a common electrode 400.

The second base substrate 310 includes a flexible material such as plastic similar to the first base substrate 110. The second coating layer 330 is arranged on an outer surface of the second substrate 300 to cover the second substrate 200. The second coating layer 330 performs the same functions as those of the first coating layer 130.

The first light reflecting layer 320 is disposed between the second base substrate 310 and the second coating layer 330 and includes a third thin layer 321 and a fourth thin layer 322. The third thin layer 321 has a third refractive index (n3) and a third thickness D3. The fourth thin layer 322 has a fourth refractive index (n4) different from the third refractive index (n3) and has a fourth thickness D4. Similar to the first and second thin layers 121 and 122, the third and fourth thin layers 321 and 322 may include an organic or inorganic material having a superior light transmittance.

The second light reflecting layer 320 reflects external ultraviolet rays 450 incident through the second coating layer 330. Especially, the second light reflecting layer 320 may reflect ultraviolet rays 450 having a specific wavelength. The approximation value of the specific wavelength may be obtained using Equation 2.

λ=2×(n3×D3+n4×D4)×sin θ Equation 2

In Equation 2, n3 and n4 represent the third and fourth refractive indexes of the third and fourth thin layers 321 and 322, respectively, D3 and D4 represent the third and fourth thicknesses of the third and fourth thin layers 321 and 322, respectively, and θ represents an angle between a surface of the third light reflecting layer 320 and the light incident into the third light reflecting layer 320.

When assuming that light is incident into the second light reflecting layer 320 at a right angle with respect to the second light reflecting layer 320 and sin θ is 1, the specific wavelength (λ) of the light reflected from the second light reflecting layer 320 may be obtained from Equation 2 using Bragg's law.

Referring to FIG. 13 and Equation 2, when manufacturing the liquid crystal display 500, the second light reflecting layer 320 is designed to reflect the ultraviolet rays 450 having a wavelength of about 308 nm that are irradiated to the second substrate 300 in order to separate a second carrier substrate 315 from the second substrate 300.

When the first and second light reflecting layers 120 and 320 are designed to have the same reflective characteristics, the first thin layer 121 and the third thin layer 321 may include the same material, the first refractive index n1 may be equal to the third refractive index n3, the second thin layer 122 and the fourth thin layer 322 may include the same material, and the second refractive index n2 may be equal to the fourth refractive index n4. In addition, a sum of the first thickness D1 and the second thickness D2 may be equal to a sum of the third thickness D3 and the fourth thickness D4.

Meanwhile, the black matrix BM is arranged at a position corresponding to the thin film transistor T and includes a metal material to block the light. The color filter CF includes a red color filter (not shown), a blue color filter (not shown), and a green color filter (not shown) and is arranged at a position corresponding to the pixel electrode PE in order to display a specific color using light incident through the liquid crystal layer 250. The common electrode 400 is arranged to cover the color filter CF and is positioned closer to the liquid crystal layer 250 than the color filter CF is. The common electrode 400 and the pixel electrode PE form an electric field therebetween to control the alignment of the liquid crystals of the liquid crystal layer 250.

In the present exemplary embodiment, the color filter CF is provided with the second substrate 300, however the color filter CF may be provided with the first substrate 100. When the color filter CF is provided with the first substrate 100, the color filter CF may be positioned above the thin film transistor T or under the thin film transistor T.

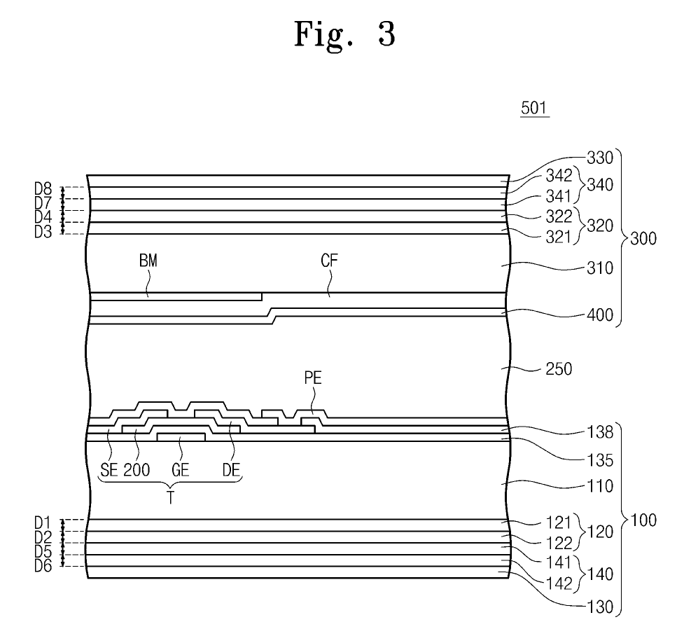

FIG. 3 is a sectional view showing a liquid crystal display according to another exemplary embodiment of the present invention.

Referring to FIG. 3, a liquid crystal display 501 further includes a third light reflecting layer 140 disposed between the first coating layer 130 and the first light reflecting layer 120 and a fourth light reflecting layer 340 disposed between the second coating layer 330 and the second light reflecting layer 320.

The third light reflecting layer 140 includes a fifth thin layer 141 and a sixth thin layer 142 disposed under the fifth thin layer 141. The fifth thin layer 141 has a fifth refractive index n5 and a fifth thickness D5. The sixth thin layer 142 has a sixth refractive index n6 and a sixth thickness D6.

The third light reflecting layer 140 selectively reflects the ultraviolet rays 450 having a wavelength that is equal to a value obtained by substituting the first refractive index n1, the second refractive index n2, the first thickness D1, and the second thickness D2 with the fifth refractive index n5, the sixth refractive index n6, the fourth thickness D4, and the sixth thickness D6 into Equation 1.

The first light reflecting layer 120 and the third light reflecting layer 140 may be designed to reflect the ultraviolet rays 450 having different wavelengths from each other. However, when the first light reflecting layer 120 and the third light reflecting layer 140 are designed to reflect the ultraviolet rays 450 having the same wavelength, the first light reflecting layer 120 and the third light reflecting layer 140 more completely reflect the ultraviolet rays 450 having the specific wavelength.

When the first light reflecting layer 120 and the third light reflecting layer 140 reflect the ultraviolet rays 450 (see FIG. 13) having the same wavelength, the first light reflecting layer 120 reflects ultraviolet rays 450 advancing toward the liquid crystal layer 250 that are not reflected by the third light reflecting layer 140. As described above, the first substrate 100 further includes the third light reflecting layer 140, and therefore, may effectively reflect the ultraviolet rays 450 advancing toward the liquid crystal layer 250.

In addition, when the first light reflecting layer 120 and the third light reflecting layer 140 are designed to reflect ultraviolet rays 450 having the same wavelength, the first and third light reflecting layers 120 and 140 may have the same structure and function. That is, the first thin layer 121 may include the same material as the fifth thin layer 141, so the first refractive index n1 may be equal to the fifth refractive index n5. The second thin layer 122 may include the same material as the sixth thin layer 142, and thus the second refractive index n2 may be equal to the sixth refractive index n6. Also, a sum of the first thickness D1 and the second thickness D2 may be equal to a sum of the fifth thickness D5 and the sixth thickness D6.

In the present exemplary embodiment, the first substrate 100 includes the first and third light reflecting layers 120 and 140. However, to more effectively reflect light advancing toward the liquid crystal 250 through the first base substrate 110, the first substrate 100 may further include a plurality of light reflecting layers having the same structures and functions as those of the first light reflecting layer 120 or the third light reflecting layer 140.

The fourth light reflecting layer 340 includes a seventh thin layer 341 and an eighth thin layer 342 arranged on the seventh thin layer 341. The seventh thin layer 341 has a seventh refractive index n7 and a seventh thickness D7. The eighth thin layer 342 has an eighth refractive index n8 and an eighth thickness D8.

The fourth light reflecting layer 340 selectively reflects ultraviolet rays 450 having a wavelength that is equal to a value obtained by substituting the third refractive index n3, the fourth refractive index n4, the third thickness D3, and the fourth thickness D4 with the seventh refractive index n7, the eighth refractive index n8, the seventh thickness D7, and the eighth thickness D8 into Equation 2.

The second light reflecting layer 320 and the fourth light reflecting layer 340 may be designed to reflect the ultraviolet rays 450 having different wavelengths from each other. However, when the second light reflecting layer 320 and the fourth light reflecting layer 340 are designed to reflect the ultraviolet rays 450 having the same wavelength, the second light reflecting layer 320 and the fourth light reflecting layer 340 may more effectively reflect the ultraviolet rays 450 having the specific wavelength.

When the second light reflecting layer 320 and the fourth light reflecting layer 340 reflect ultraviolet rays 450(see FIG. 13) having the same wavelength, the second light reflecting layer 320 may reflect the ultraviolet rays 450 advancing toward the liquid crystal layer 250 that are not reflected by the fourth light reflecting layer 340. As described above, the second substrate 300 further includes the fourth light reflecting layer 340, and therefore, may effectively reflect the ultraviolet rays 450 advancing toward the liquid crystal 250.

In the present exemplary embodiment, the second substrate 300 includes the second and fourth light reflecting layers 320 and 340. However, in order to effectively reflect light advancing toward the liquid crystal layer 250 through the second base substrate 310, the second substrate 300 may further include a plurality of light reflecting layers having the same structures and functions as those of the second light reflecting layer 320 or the fourth light reflecting layer 340.

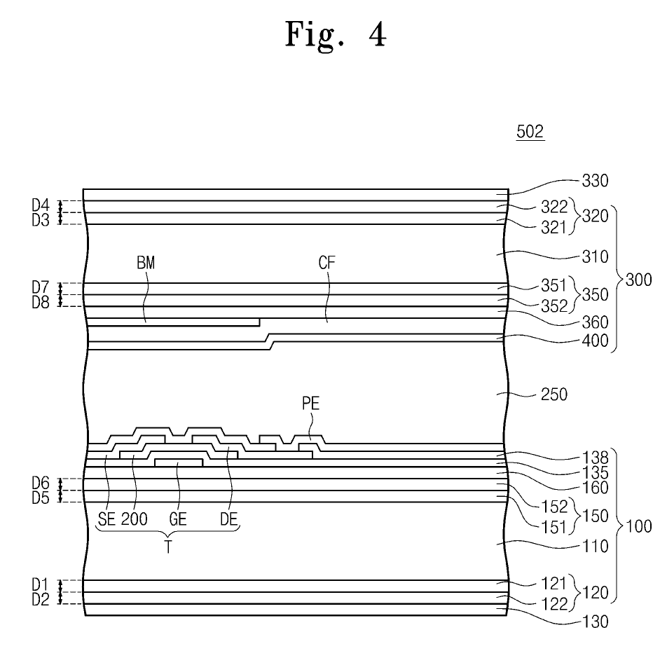

FIG. 4 is a sectional view showing a liquid crystal display according to another exemplary embodiment of the present invention. In FIG. 4, the same reference numerals denote the same elements of FIG. 1, and thus the detailed description of the same elements will be omitted.

Referring to FIG. 4, a liquid crystal display 502 further includes a third light reflecting layer 150, a third coating layer 160, a fourth light reflecting layer 350, and a fourth coating layer 360, as compared with the above-mentioned liquid crystal display 500.

The third light reflecting layer 150 faces the first light reflecting layer 120 with the first base substrate 110 disposed therebetween, and the third coating layer 160 is arranged on the third light reflecting layer 150. The fourth light reflecting layer 350 faces the second light reflecting layer 320 with the second base substrate 310 disposed therebetween, and the fourth coating layer 360 is arranged under the fourth light reflecting layer 350.

The third light reflecting layer 150 includes a fifth thin layer 151 and a sixth thin layer 152 arranged on the fifth thin layer 151. The fourth light reflecting layer 350 includes a seventh thin layer 351 and an eighth thin layer 352 arranged under the seventh thin layer 351.

In the liquid crystal display 502, the third light reflecting layer 150 is positioned at a position different from that of the third light reflecting layer 140 (see, FIG. 3) of the liquid crystal display 501 (see, FIG. 3) according to the above-mentioned exemplary embodiment. However, the third light reflecting layer 150 according to the present exemplary embodiment may have the same material and function as those of the third light reflecting layer 140 of the liquid crystal display 501 (see, FIG. 3) according to the above-mentioned exemplary embodiment.

In addition, in the liquid crystal display 502, the fourth light reflecting layer 350 is positioned at a position different from that of the fourth light reflecting layer 340 (see FIG. 3) of the liquid crystal display 501 (see FIG. 3) according to the above-mentioned exemplary embodiment. However, the fourth light reflecting layer 350 according to the present exemplary embodiment may include the same material and have the function as those of the fourth light reflecting layer 340 of the liquid crystal display 501 (see FIG. 3) according to the above-mentioned exemplary embodiment.

Meanwhile, the third coating layer 160 may include the same material as the first coating layer 130. The third coating layer 160 is positioned to face the first coating layer 130 with the first base substrate 110 disposed therebetween, thereby preventing the first base substrate 110 from being bent by temperature variations. More particularly, the first base substrate 110 may have a thermal expansion rate different from that of the first coating layer 130. Thus, if the first coating layer 130 is formed on only one surface of the first base substrate 110, the first base substrate 110 may be bent due to the difference of the thermal expansion rate between the first base substrate 110 and the first coating layer 130.

However, when the first coating layer 130 and the third coating layer 160 are formed on opposite surfaces of the first base substrate 110, bending of the first base substrate 110 may be prevented since the first and third coating layers 130 and 160 may have the same thermal expansion rate and support both surfaces of the first base substrate 110.

Also, the fourth coating layer 360 may include the same material as the second coating layer 330. The fourth coating layer 360 is positioned to face the second coating layer 330 with the second base substrate 310 disposed therebetween, thereby preventing the second base substrate 310 from being bent by temperature variation.

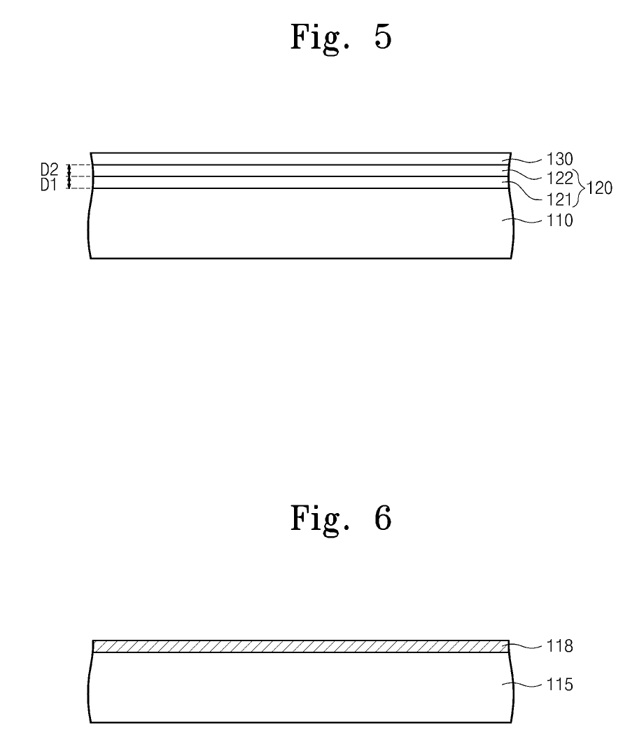

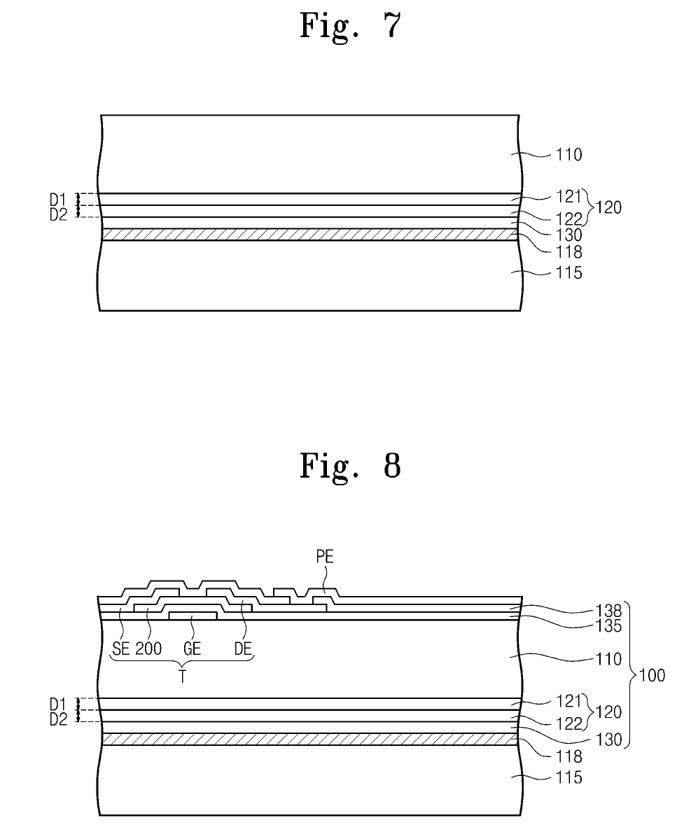

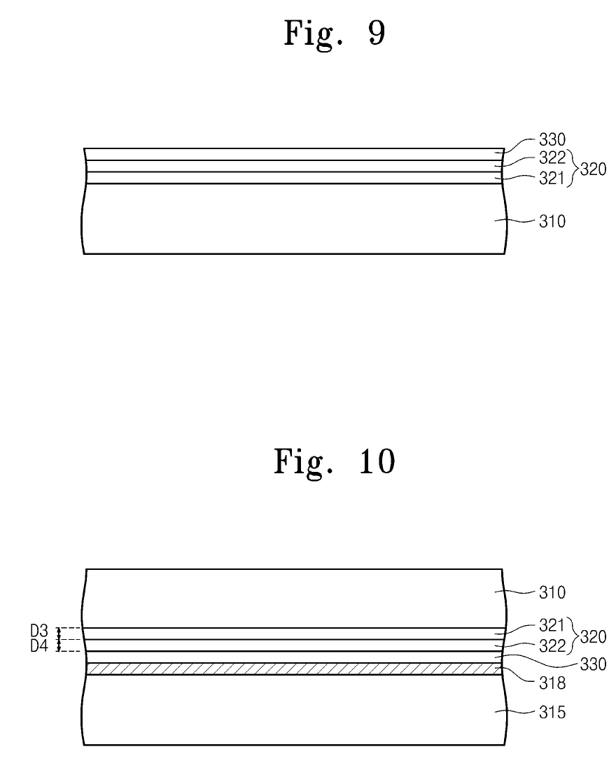

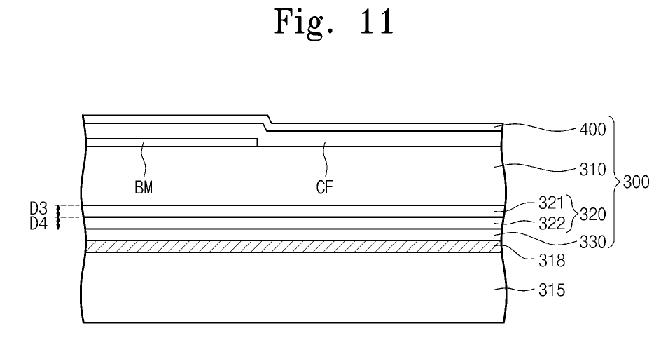

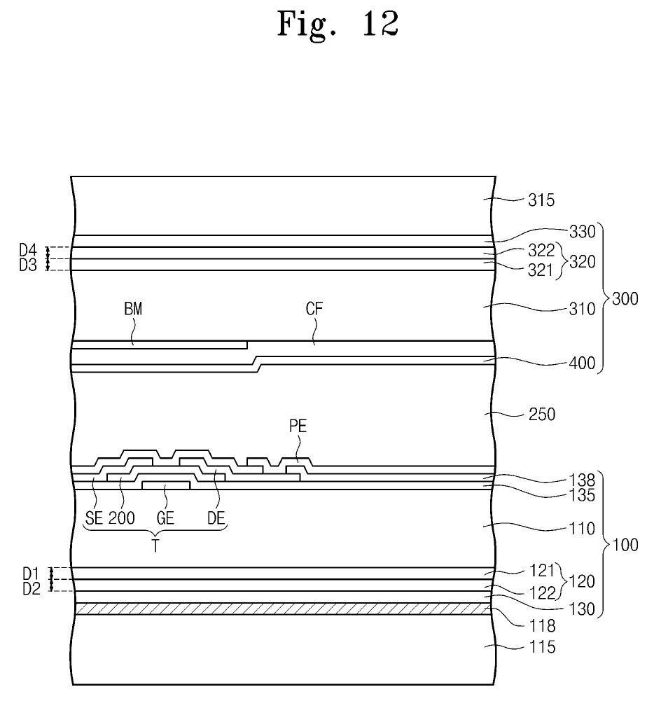

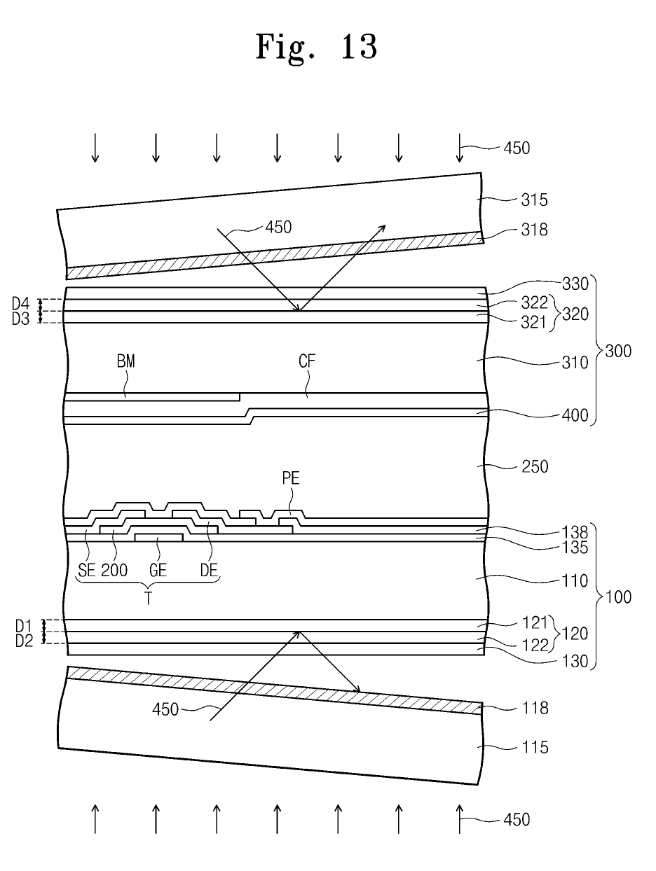

FIG. 5, FIG. 6, FIG. 7, FIG. 8, FIG. 9, FIG. 10, FIG. 11, FIG. 12, and FIG. 13 are process views showing a method of manufacturing the liquid crystal display of FIG. 1.

Referring to FIG. 5, the first thin layer 121 and the second thin layer 122 are sequentially formed on the first base substrate 110, thereby forming the first light reflecting layer 120 including the first and second thin layers 121 and 122. The first coating layer 130 is formed on the first light reflecting layer 120.

Referring to FIG. 6 and FIG. 7, a first adhesive layer 118 is formed on a first carrier substrate 115. Then, the first carrier substrate 115 is combined with the first base substrate 110 using the first adhesive layer 118 so that the first light reflecting layer 120 is positioned between the first base substrate 110 and the first adhesive layer 118.

The first carrier substrate 115 is combined with the first base substrate 110 because the first base substrate 110 may include flexible material. That is, it may be difficult to form the thin film transistor T (see, FIG. 8), the gate insulating layer 135, and the inter-insulating layer 138 on the first base substrate 100. Accordingly, when the processes for forming the thin film transistor T (see, FIG. 8), the gate insulating layer 135, and the inter-insulating layer 138 on the first base substrate 110 start after the first carrier substrate 115 is attached to the rear surface of the first base substrate 110, the processes may be performed more easily.

Referring to FIG. 8, the thin film transistor T, the pixel electrode PE connected to the thin film transistor T, the gate insulating layer 135, and the inter-insulating layer 138 are formed on the first base substrate 110. Although not shown in FIG. 8, plural processes are performed to the first base substrate 110 the first base substrate 110 may serve as a display substrate. As a result, the first substrate 100 that is combined with the first carrier substrate 115 by the first adhesive layer 118 is manufactured.

Referring to FIG. 9, the third thin layer 321 and the fourth thin layer 322, which make up the second light reflecting layer 320, are sequentially formed on the second base substrate 310. Then, the second coating layer 330 is formed on the second light reflecting layer 320.

Referring to FIG. 10, a second adhesive layer 318 is formed on a second carrier substrate 315. The second carrier substrate 315 is combined with the second base substrate 310 using the second adhesive layer 318 so that the second light reflecting layer 320 is positioned between the second base substrate 310 and the second adhesive layer 318.

Referring to FIG. 11, the black matrix BM, the color filter CF, and the common electrode 400 are formed on the second base substrate 310. Although not shown in FIG. 11, plural processes are performed to the second base substrate 310 such that the second base substrate 310 has functions needed to serve as a display substrate. As a result, the second substrate 300 that is combined with the second carrier substrate 315 by the second adhesive layer 318 is manufactured.

Referring to FIG. 12 and FIG. 13, the first substrate 100 is coupled to the second substrate 300 and the liquid crystal layer 250 is disposed between the first and second substrates 100 and 300. Although not shown in FIG. 12 and FIG. 13, the first and second substrates 100 and 300 may be coupled with each other by a sealant that is formed along an edge of the first substrate 100 or the second substrate 300.

After the first and second substrates 100 and 300 are coupled with each other, ultraviolet rays 450 having a wavelength of about 308 nm are irradiated onto the first adhesive layer 118, so that the first carrier substrate 115 may be separated from the first substrate 100. The first adhesive layer 118 may be separated from the first substrate 100 together with the first carrier substrate 115, or the first adhesive layer 118 may be removed by an additional process after separating the first carrier substrate 115 from the first substrate 100.

During the irradiation of ultraviolet rays 450 onto the first adhesive layer 118, portions of the ultraviolet rays 450 pass through the first adhesive layer 118 and advance toward the liquid crystal layer 250. However, the first light reflecting layer 120 positioned between the first adhesive layer 118 and the liquid crystal 250 reflects the ultraviolet rays 450 before they reach the liquid crystal layer 250. Thus, since the first light reflecting layer 120 prevents the irradiation of ultraviolet rays 450 onto the liquid crystal layer 250, variations in the chemical and physical properties of the liquid crystal layer 250 due to the ultraviolet rays 450 may be prevented.

Similarly, ultraviolet rays 450 having a wavelength of about 308 nm are irradiated onto the second adhesive layer 318 to separate the second carrier substrate 315 from the second substrate 300. During irradiation of the ultraviolet rays 450 onto the second adhesive layer 318, portions of the ultraviolet rays 450 pass through the second adhesive layer 318 and advance toward the liquid crystal layer 250. However, the second light reflecting layer 320 positioned between the second adhesive layer 318 and the liquid crystal layer 250 reflects the ultraviolet rays 450 before they reach the liquid crystal layer 250.

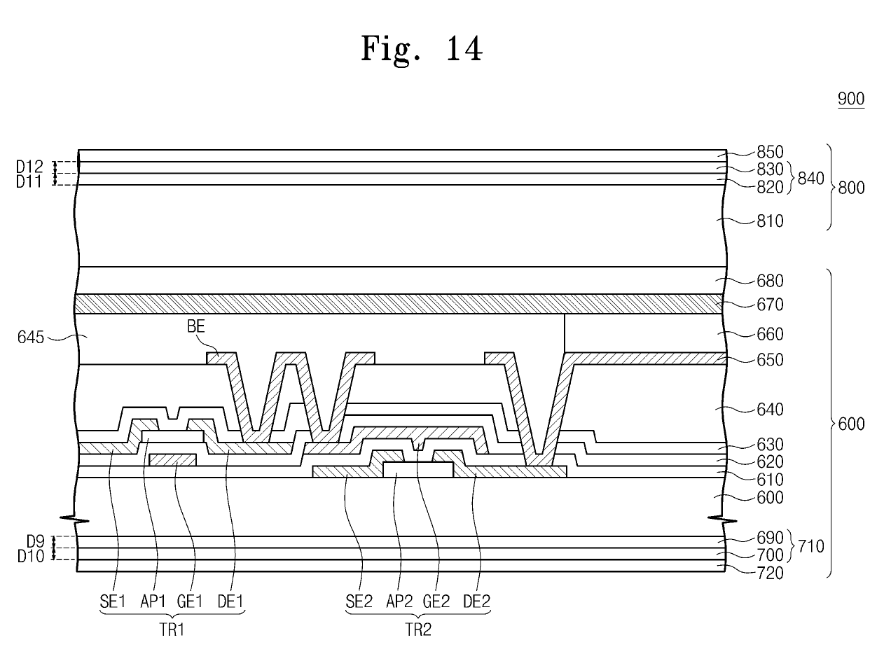

FIG. 14 is a sectional view showing an organic light emitting device according to an exemplary embodiment of the present invention.

Referring to FIG. 14, an organic light emitting device 900 includes an array substrate 600 and a cover substrate 800.

The array substrate 600 includes a first base substrate 600, a first thin film transistor TR1, a second thin film transistor TR2, a first electrode 650, an organic light emitting layer 660, a second electrode 670, a first light reflecting layer 710, a second light reflecting layer 840, and a first coating layer 720 arranged on an outer surface of the array substrate 600.

The first thin film transistor TR1 includes a first gate electrode GE1, a first source electrode SE1, a first drain electrode DE1, and a first active pattern AP1. Although not shown in FIG. 14, a gate line and a data line are formed on the first base substrate 600, the first gate electrode GE1 branches from the gate line, and the first source electrode SE1 branches from the data line.

The first thin film transistor TR1 is turned on in response to a gate signal applied through the gate line and the first gate electrode GE1. When the first thin film transistor TR1 is turned on, the first active pattern AP1 is activated, so that a data signal transmitted through the data line and the first source electrode SE1 is applied to the first drain electrode DE1 through the first active pattern AP1.

The second thin film transistor TR2 includes a second gate electrode GE2, a second source electrode SE2, a second drain electrode DE2, and a second active pattern AP2. Although not shown in FIG. 14, a bias line that applies a power source voltage to the organic light emitting layer 660 is formed on the first base substrate 600, and the second source electrode SE2 branches from the bias line.

The second gate electrode GE2 is connected to the first drain electrode DE1 by a bridge electrode BE. Accordingly, the second thin film transistor TR2 may be turned on by the data signal applied through the first drain electrode DE1. When the second thin film transistor TR2 is turned on, the second active pattern AP2 is activated, a driving voltage that is transmitted through the bias line and the second source electrode SE2 is applied to the second drain electrode DE2 through the second active pattern AP2.

Meanwhile, the array substrate 600 includes a first insulating layer 610, a second insulating layer 620, a third insulating layer 630, a fourth insulating layer 640, and a fifth insulating layer 645. The first insulating layer 610 is positioned between the first base substrate 600 and the first gate electrode GE1, and the second insulating layer 620 is positioned between the first active pattern AP1 and the first gate electrode GE. The third insulating layer 630 is arranged on the first source electrode SE1 and the drain electrode DE1, and the fourth insulating layer 640 is arranged on the third insulating layer 630. The fifth insulating layer 645 is arranged on the fourth insulating layer 640.

The first electrode 650 is connected to the second drain electrode DE2, and the organic light emitting layer 660 is arranged on the first electrode 650 such that the organic light emitting layer 660 contacts the first electrode 650. The second electrode 670 is arranged on and contacts the organic light emitting layer 660.

In the present exemplary embodiment, the first electrode 650 may include a conductive material having superior light transmittance, such as indium tin oxide, indium zinc oxide, or the like, and the second electrode 670 may include a metal material such as aluminum, silver, copper, or the like. Accordingly, when the organic light emitting layer 660 emits light according to supply of the voltage to the first and second electrodes 650 and 670, the light is reflected from a surface of the second electrode 670 and exits through the first base substrate 600.

A protective layer 680 is arranged on the second electrode 670. The protective layer 680 is positioned at an uppermost portion of the array substrate 600 to prevent moisture or gas from being infiltrated into the organic light emitting layer 660.

The first light reflecting layer 710 is arranged under the first base substrate 600. The first light reflecting layer 710 may have the same structure and function as the first light reflecting layer 120 of the liquid crystal display 500 shown in FIG. 2. That is, the first light reflecting layer 710 includes a first thin film 690 and a second thin film 700 arranged under the first thin film 690. The first and second thin films have different refractive indexes from each other and have a ninth thickness D9 and a tenth thickness D10, respectively.

Thus, the wavelength of light reflected by the first light reflecting layer 710 may be controlled by adjusting at least one of the refractive index of the first thin film 690, the refractive index of the second thin film 700, the ninth thickness D9, and the tenth thickness D10, as illustrated by Equation 1.

The cover substrate 800 includes a second base substrate 810, the second light reflecting layer 840 arranged on the second base substrate 810, and a second coating layer 850 arranged on an outer surface of the cover substrate 800.

The second light reflecting layer 840 is arranged under the second base substrate 810. The second light reflecting layer 840 may have same structure and function as the second light reflecting layer 320 (see, FIG. 2) of the liquid crystal display 500 as shown in FIG. 2. Particularly, the second light reflecting layer 840 includes a third thin film 820 and a fourth thin film 830 arranged on the third thin film 820. The third and fourth thin films 820 and 830 have different refractive indexes from each other and have an eleventh thickness D11 and a twelfth thickness D12, respectively.

Accordingly, the wavelength of light reflected by the second light reflecting layer 840 may be controlled by adjusting at least one of the refractive index of the third thin film 820, the refractive index of the fourth thin film 830, the eleventh thickness D11, and the twelfth thickness D12, as illustrated by Equation 2.

According to the display apparatus and the manufacturing method for the display apparatus, the ultraviolet rays that are applied to the substrate to remove the carrier substrate from the substrate may be reflected by the light reflecting layer arranged on the substrate. Thus, deterioration of the driving performance of the display apparatus due to the energy of the ultraviolet rays may be prevented.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A display apparatus, comprising:
a first substrate;
a second substrate facing the first substrate;
an optical shutter disposed between the first substrate and the second substrate; and
a light reflecting layer arranged on at least one of the first substrate and the second substrate to reflect ultraviolet rays that comprise a specific wavelength and that are irradiated onto the at least one of the first substrate and the second substrate,
wherein the light reflecting layer comprises:
a first layer comprising a first refractive index; and
a second layer comprising a second refractive index different from the first refractive index and arranged on the first layer.

2. The display apparatus of claim 1, wherein the first layer and the second layer are alternately stacked on each other.

3. The display apparatus of claim 1, further comprising a coating layer arranged on an outer surface of each of the first substrate and the second substrate.

4. The display apparatus of claim 1, wherein the specific wavelength is adjusted by altering at least one of a thickness of the light reflecting layer, the first refractive index, and the second refractive index.

5. The display apparatus of claim 4, wherein the wavelength is about 308 nm.

6. The display apparatus of claim 1, wherein each of the at least one first layer and the at least one second layer comprises an organic material or an inorganic material.

7. The display apparatus of claim 6, wherein the organic material comprises one of a polyacrylate polymer, polystyrene, and polyimide.

8. The display apparatus of claim 6, wherein the inorganic material comprises one of zinc oxide (ZnO), indium zinc oxide (IZO), indium tin oxide (ITO), silicon oxide (SiOₓ), aluminum oxide (AlₓO_{y}), and titanium oxide (TiOₓ).

9. The display apparatus of claim 1, wherein each of the first substrate and the second substrate comprises a flexible substrate.

10. The display apparatus of claim 1, wherein the optical shutter is a liquid crystal.

11. A method of manufacturing a display apparatus, comprising:
sequentially forming a first layer having a first refractive index and a second layer having a second refractive index different from the first refractive index on a first substrate to form a first light reflecting layer to reflect ultraviolet rays having a first wavelength;
forming a first adhesive layer on a first carrier substrate;
coupling the first substrate with the first carrier substrate such that the first light reflecting layer is disposed between the first substrate and the first adhesive layer;
sequentially forming a third layer having a third refractive index and a fourth layer having a fourth refractive index different from the third refractive index on a second substrate to form a second light reflecting layer to reflect ultraviolet rays having a second wavelength;
forming a second adhesive layer on a second carrier substrate;
coupling the second substrate with the second carrier substrate such that the second light reflecting layer is disposed between the second substrate and the second adhesive layer; and
coupling the first substrate with the second substrate,
wherein an optical shutter is disposed between the first substrate and the second substrate.

12. The method of claim 11, further comprising:
sequentially forming at least one more first layer and at least one more second layer on the first substrate before coupling the first substrate with the first carrier substrate; and
sequentially forming at least one more third layer and at least one more fourth layer on the second substrate before coupling the second substrate with the second carrier substrate,
wherein the first layers and the second layers are alternately stacked on each other, and the third layers and the fourth layers are alternately stacked on one another.

13. The method of claim 12, wherein a number of the first layers is equal to a number of the second layers, and a number of the third layers is equal to a number of the fourth layers.

14. The method of claim 11, further comprising:
irradiating ultraviolet rays having the first wavelength onto the first adhesive layer to separate the first carrier substrate from the first substrate; and
irradiating ultraviolet rays having the second wavelength onto the second adhesive layer to separate the second carrier substrate from the second substrate.

15. The method of claim 14, wherein the first light reflecting layer reflects the ultraviolet rays that are irradiated onto the first substrate and have the first wavelength, and the second light reflecting layer reflects ultraviolet rays that are irradiated onto the second substrate and have the second wavelength.

16. The method of claim 15, wherein the first wavelength is adjusted by altering at least one of a thickness of the first light reflecting layer, the first refractive index, and the second refractive index, and the second wavelength is adjusted by altering at least one of a thickness of the second light reflecting layer, the third refractive index, and the fourth refractive index.

17. The method of claim 16, wherein each of the first wavelength and the second wavelength is about 308 nm.

18. The method of claim 11, further comprising:
forming a first coating layer on the first light reflecting layer before coupling the first substrate and the first carrier substrate; and
forming a second coating layer on the second light reflecting layer before coupling the second substrate and the second carrier substrate.

19. The method of claim 11, wherein each of the first substrate and the second substrate comprises a flexible substrate.

20. The method of claim 11, wherein each of the first layer, the second layer, the third layer, and the fourth layer comprises an organic material or an inorganic material.

21. The method of claim 20, wherein the first layer and the second layer comprise the organic material, and the third layer and the fourth layer comprise the inorganic material.

22. The method of claim 11, wherein the optical shutter is a liquid crystal.

23. An organic light emitting display, comprising:
a first substrate:
a second substrate facing the first substrate;
an organic light emitting layer arranged on the first substrate to emit light; and
a light reflecting layer arranged on at least one of the first substrate and the second substrate to reflect ultraviolet rays that have a specific wavelength and that are irradiated onto at least one of the first substrate or the second substrate,
wherein each light reflecting layer comprises:
a first layer having a first refractive index; and
a second layer having a second refractive index different from the first refractive index and arranged on the first layer.

24. The organic light emitting display of claim 23, wherein the specific wavelength is adjusted by altering at least one of a thickness of the light reflecting layer, the first refractive index, and the second refractive index.
